(19) United States
(12) Patent Application Publication
(10) Pub. No.: US 2013/0342445 A1
(43) Pub. Date: Dec. 26, 2013

(54) EXTERNAL RECORDING DEVICE COMBINED WITH INPUT UNIT

(71) Applicant: TOSHIBA SAMSUNG STORAGE TECHNOLOGY KOREA CORPORATION, Suwon-si (KR)

(72) Inventor: Jung Bae OH, Suwon-si (KR)

(21) Appl. No.: 13/923,538

(22) Filed: Jun. 21, 2013

(30) Foreign Application Priority Data
Jun. 21, 2012 (KR) 10-2012-0066940

(51) Int. Cl. G06F 3/023

(52) U.S. Cl. CPC G06F 3/0233
USPC 345/156

(57) ABSTRACT

Provided is an external recording device including a text input unit capable of inputting text or data to a terminal device.

### CROSS-REFERENCE TO RELATED APPLICATIONS

This application claims the benefit under 35 U.S.C. §119(a) of Korean Patent Application No. 10-2012-0066940, filed on Jun. 21, 2012, in the Korean Intellectual Property Office, the entire disclosure of which is incorporated herein by reference for all purposes.

### BACKGROUND

1. Field

The following description relates to an external recording device combined with a keypad. The keypad may be capable of inputting a text, such as a number, a character, and the like.

2. Description of Related Art

Recent advance in technology have allowed the manufacturing of electronic devices in a slim form while maintaining performance and quality. For example, notebooks are being manufactured in an ultra slim form, sometimes referred to as ultra-books, having a significantly smaller thickness than ordinary notebooks.

A slim personal computer (PC) or a slim notebook often includes a keyboard in which a number keypad is excluded. Though in some situations the number keypad is not used by a user, the number keypad may be required based on an operation type of the user. For example, a number keypad may be used for manipulating a unit in a game or for accounting operations.

Further, in many cases, a slim PC or a slim notebook may not include an optical disk drive (ODD) capable of recording data to a storage medium, such as CD-ROM and DVD-ROM. This is often done for a variety of reasons, such as reducing device thickness, noise, and heat generation.

### SUMMARY

In a general aspect, there is provided a recording device including: a data recording unit configured to record to a storage medium data that is received from a terminal device; and a text input unit that is on a surface of the data recording unit for enabling a user to input text into the terminal device.

The text input unit may be a keypad that is capable of being separated and spaced apart from the data recording unit by the user.

The text input unit may be configured to receive or transmit data by wireless communication with the terminal device in response to being separated and spaced apart from the data recording unit.

The text input unit may be a keypad that is capable of slidably detaching from and reattaching to the data recording unit by the user.

The text input unit may comprise a supporter for supporting the text input unit on a surface in response to the text input unit being detached from the data recording unit.

The text input unit may be a keypad that comprises any one or any combination of a number key, a character key, and an emoticon key.

The text input unit may enable the user to input any one or any combination of a number, a character, and an emoticon using a touch scheme or a typing scheme.

The storage medium may be any one or any combination of an optical disk and a hard disk.

The text input unit may be configured to receive data identification information from the user and to label the storage medium with the data identification information.

The text input unit may include a display configured to enable the user to verify whether data identification information is input.

In another general aspect, there is provided a recording device, including: an opening for receiving an optical disk, wherein the recording device is capable of recording data to the optical disk and is connected to a keypad that is capable of inputting text into a terminal device.

The keypad may be capable of being separated and spaced apart from a data recording unit by a user.

The keypad may be capable of slidably detaching from and reattaching to a data recording unit by a user.

The keypad may include a supporter for supporting the keypad on a surface in response to the keypad being detached from the data recording unit.

The recording device may be configured to label the optical disk with data identification information in response to the data identification information being received by the keypad.

The keypad may include any one or any combination of a number key, a character key, and an emoticon key that enable a user to input any one or any combination of a number, a character, and an emoticon using a touch scheme or a typing scheme.

The keypad may include any one or any combination of a number key, a character key, and an emoticon key.

In another general aspect, there is provided a keypad, including: a surface for combining with an upper plate of a recording device, wherein the recording device is capable of recoding data to a storage medium; and the keypad is capable of transmitting input data to a terminal device.

The keypad may be capable of being separated and spaced apart from the recording device or slidably detaching from and reattaching to the recording device.

### BRIEF DESCRIPTION OF THE DRAWINGS

FIG. 1 is a diagram illustrating an example of an operation of an external recording device.

FIG. 2 is a block diagram illustrating an example of a configuration of an external recording device.

FIG. 3 is a diagram illustrating an example of an external recording device combined with a keypad.

FIG. 4 is a diagram illustrating an example in which a keypad combined with an external recording device is separated and spaced apart from the external recording device.

FIG. 5 a diagram illustrating an example in which a keypad combined with an external recording device slidably moves relative to the external recording device.

FIG. 6 is a diagram illustrating an example of an operation scheme of a keypad combined with an external recording device.

FIG. 7 is a diagram illustrating an example of a labeling process for a storage medium using a keypad combined with an external recording device.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. Also, descriptions of functions and constructions that are well known to one of ordinary skill in the art may be omitted for increased clarity and conciseness.

Throughout the drawings and the detailed description, the same reference numerals refer to the same elements. The drawings may not be to scale, and the relative size, proportions, and depiction of elements in the drawings may be exaggerated for clarity, illustration, and convenience.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

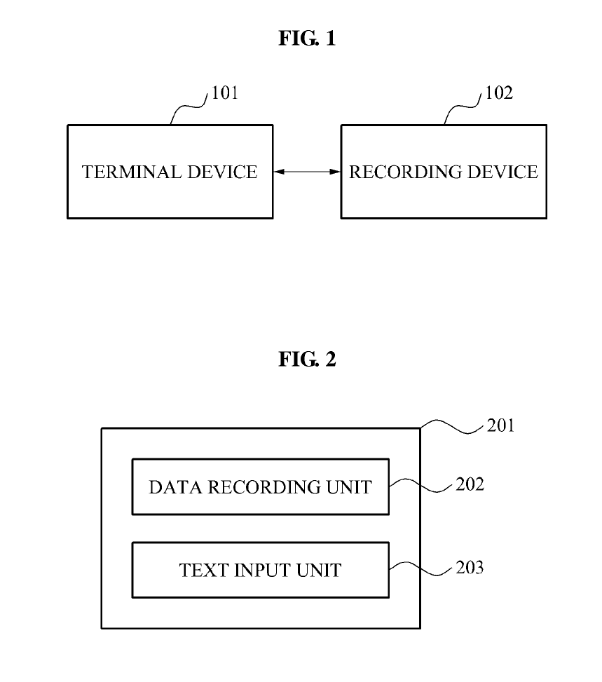

FIG. 1 is a diagram illustrating an example of an operation of an external recording device.

Referring to FIG. 1, a terminal device 101 and a recording device 102 are independently provided. For example, the terminal device 101 may include any type of data processing device, such as a personal computer (PC), a notebook, a television (TV), an audio source, a mobile phone, a tablet PC, a mobile terminal such as a personal digital assistant (PDA), and the like. The recording device 102 may be positioned outside the terminal device 101 to store, in a storage medium, data received from the terminal device 101. In an example, the recording device 102 includes an optical disk drive (ODD) capable of recording data to the storage medium, such as CD-ROM, DVD-ROM, and blue-ray. The recording device 102 may also include a hard disk drive (HDD), a solid state drive (SSD), and the like.

In this example, the recording device 102 is combined with an element configured to record data and an element capable of inputting a text into the terminal device 101. The recording device 102 records data received from the terminal device 101, and may transfer to the terminal device 101 a text input by a user.

FIG. 2 illustrates an example of a configuration of a recording device 201.

Referring to FIG. 2, the recording device 201 includes a data recording unit 202 and a text input unit 203.

In this example, the recording device 201 includes a data recording unit 202 that records data received from a terminal device. For example, the data recording unit 202 is an ODD capable of recording data to a storage medium, an HDD, an SSD, and the like. In this example, the data recording unit 202 is provided as an external unit that is not positioned within the terminal device and independently operates outside the terminal device.

In this example, the recording device 201 includes a text input unit 203. For example, the text input unit 203 is a keypad that enables a user to input a text, such as a number, a character, or an emoticon. In this example, the text input unit 203 is combined with the outside of the data recording unit 202 on an upper end thereof. The user inputs a text into the terminal device by directly typing or touching the text using the text input unit 203.

When the terminal device does not include an element capable of inputting a text or includes an element configured to allow only a limited text input, the user may easily input a text into the terminal device using the text input unit 203. Further, the text input unit 203 may be configured as a keypad capable of being combined with the outside of an external recording device that is currently manufactured and on sale.

In an example, the text input unit 203 is configured as an interface that enables the user to input a text using a typing scheme or a touch scheme. When the user inputs the text using the typing scheme, the text input unit 203 is configured to include a plurality of keys such as a keyboard. When the user inputs the text using the touch scheme, the text input unit 203 is configured as a display capable of digitally representing a plurality of keys. The display may include a liquid crystal display (LCD), a light emitting diode (LED), an organic light emitting diode (OLED), and the like.

In an example, the text input unit 203 may be separated and spaced apart from the data recording unit 202 by the user. For example, the user may separate the text input unit 203 combined with the data recording unit 202 and may use the separated text input unit 203. In this example, when the user inputs a text using a typing scheme or a touch scheme, the text input unit 203 transmits the input text to the terminal device through a near field wireless communication scheme. For example, the wireless communication scheme includes Bluetooth, radio frequency identification (RFID), and wireless fidelity (WiFi), and the like.

In this example, the text input unit 203 may be slidably movable from the data recording unit 202 by the user. For example, the user may separate the text input unit 203 from the data recording unit 202 by sliding the text input unit 203. In this example, the text input unit 203 may include a supporter capable of supporting the text input unit 203 on a surface when the text input unit 203 is separated. The supporter may be made to protrude from the text input unit 203 by the user when the user desires to use the supporter. Alternatively, the supporter or may automatically protrude from the text input unit 203.

In an example, the text input unit 203 labels a storage medium on which data is recorded by the data recording unit 202 with identification information for identifying the recorded data. Also, the text input unit 203 may label a storage medium on which data has already been recorded or on which data will be recorded. In this example, the user directly labels the identification information on the recording medium through the text input unit 203. Labeling may generally be understood as any marking of identification information on the recording medium.

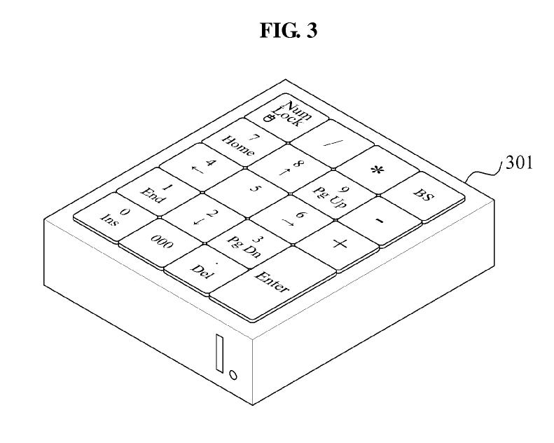

FIG. 3 illustrates an example of an external recording device 301 combined with a keypad.

Referring to FIG. 3, the external recording device 301 includes a disk drive to record data and a keypad that enables a user to directly input a text, such as a number, a character, or an emoticon. For example, the external recording device 301 performs an operation of recording, to a storage medium, data received from a terminal device. Also, the external recording device performs an operation of inputting a text to the terminal device. Hereinafter, a description will be made of an example where the disk drive is an ODD.

Referring to FIG. 3, even though the keypad arrangement is shown as including specific numbers and characters, the keypad arrangement may include any combination of numbers, characters, letter, and emoticons depending on the desire of a user or manufacturer. Also, even though the keypad is shown having a particular orientation on an upper end of the disk drive, a combination position of the keypad is not limited thereto and may be modified in various ways.

Further, in this example, the terminal device does not have a text input keypad and allows only a limited text input. Nevertheless, a user may input text using the numerical keypad where the number keys have a text input ability. For example, a key for “1” may also be used to input letters “a”, “b”, or “c” based on the number of times the key is pressed.

In another example, the keypad may have specific text keys allowing a user to more easily input the text.

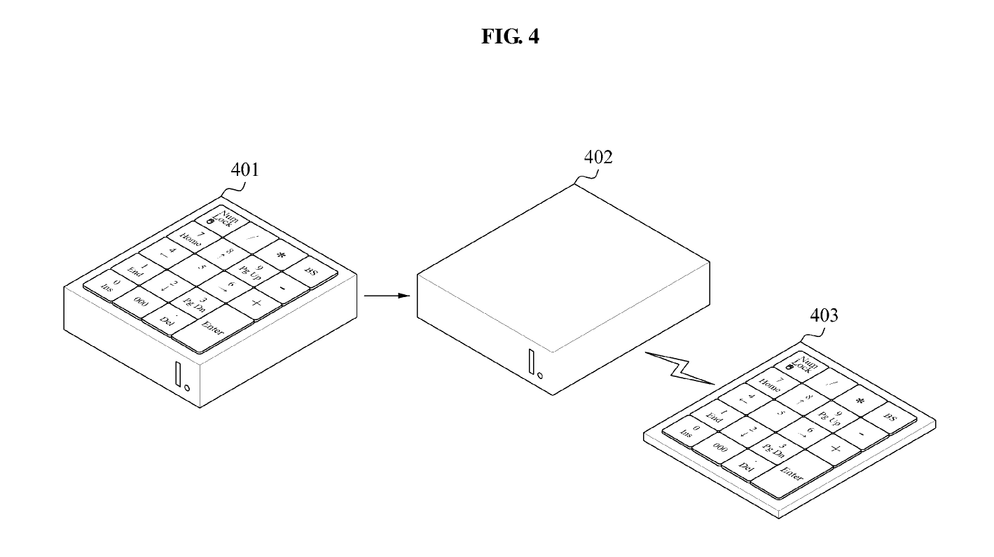

FIG. 4 illustrates an example in which a keypad 403 combined with an external recording device 401 is separated and spaced apart from the external recording device 401. Referring to FIG. 4, the external recording device 401 combines an ODD 402 with the keypad 403. To better accommodate certain desired operations of a user, the keypad 403 may be separated and spaced apart from the ODD 402.

In this example, the user may input text using the keypad 403 while the keypad 405 is separated from the ODD 402. Accordingly, it is possible to avoid the potential inconvenience of vibrations or heat coming from the ODD 402.

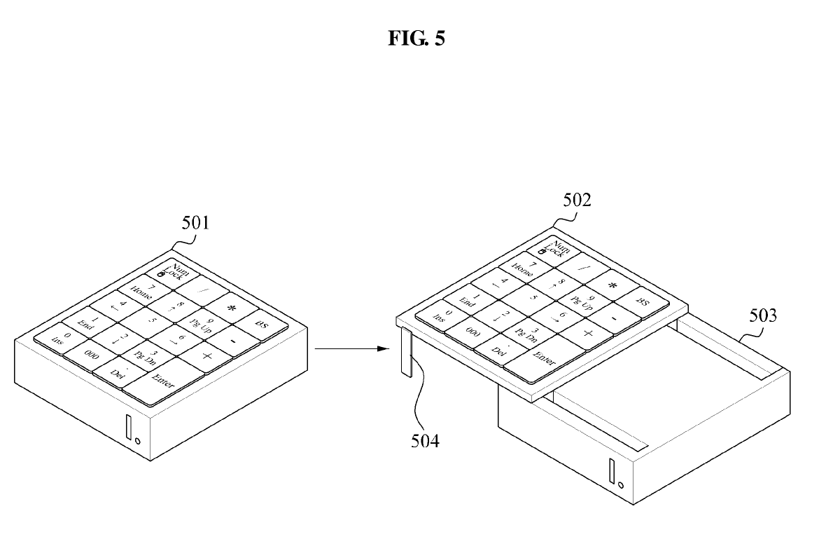

FIG. 5 illustrates an example in which a keypad 502 is slidably attachable and detachable from a recording device 501.

Referring to FIG. 5, the external recording device 501 combines an ODD 503 with the keypad 502. In this example, the keypad 502 is slid and moved from the ODD 503 by manipulation of a user. The keypad 502 includes a supporter 504 configured to support the keypad 502 on a surface when the keypad 502 is slid from the ODD 503. The height of the supporter 504 may be adjustable, and the supporter 504 may be capable of bending by user manipulation or may bend automatically once the keypad 502 is slid from the ODD 503.

The user may input a text using the keypad 502 while the keypad 502 is slid and moved from the ODD 503. Accordingly, it is possible to avoid the potential inconvenience of vibration or heat coming from the ODD 503.

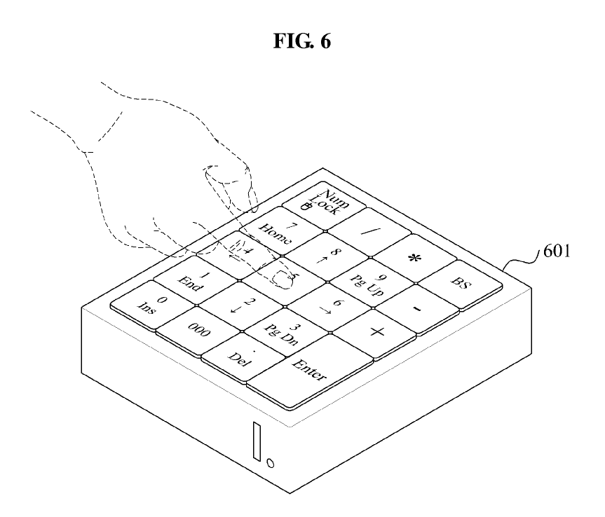

FIG. 6 illustrates an example of an operation scheme of a keypad combined with an external recording device 601.

Referring to FIG. 6, the external recording device 601 includes an ODD and a keypad. In this example, the keypad includes a plurality of keys or a display capable of digitally representing a plurality of keys. For example, the display may include an LCD, an LED, an OLED, and the like. When the keypad is configured as a display, a user may input a text by pushing a key using a touch scheme.

The keypad may include any one or any combination of a number, a character, and an emoticon. For example, the keypad may include various key combinations, such as a number, number+character, number+emoticon, and character+emoticon. In this example, a key arrangement shown on the display of the keypad may vary based on a mode selection of the user. Additionally, several key arrangements may be designed for the display or actual plurality of keys of the keypad.

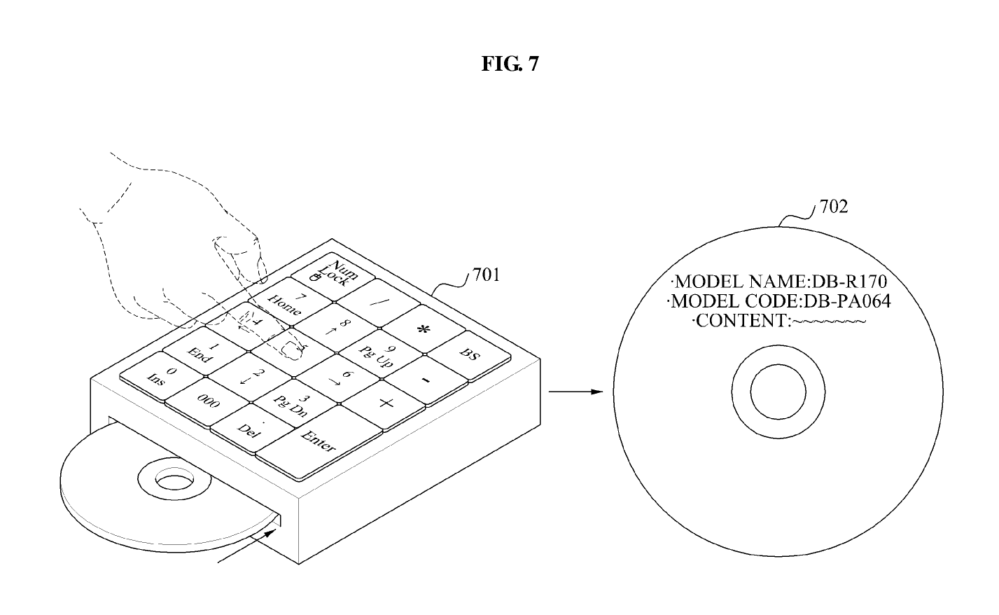

FIG. 7 illustrates an example of a labeling process for a storage medium 702 using a keypad combined with an external recording device 701.

Referring to FIG. 7, a user may input a text using the keypad included in the external recording device 701. In this example, the input text directly labels the recording medium 702. The input text may be identification information of data recorded on the recording medium 702. For example, compared to inputting identification information on the recording medium 702 by hand, the user may easily input the identification information by inputting a text using the keypad of the external recording device 701. In this example, the keypad may include a display that enables the user to verify whether the identification information has been properly input.

According to various aspects, an external recording device may be combined with a keypad capable of inputting a text such as a character, a number, or an emoticon for enabling a user to easily input the text to a terminal device.

According to various aspects, a keypad combined with an external recording device is capable of being separated and spaced apart from the external recording device in order to accommodate different types of uses or operations by a user. Additionally, the keypad may be slidably attachable or detachable from the external recording device in order to provide greater convenience in using the keypad.

The terminal device, recording device, keypad, data recording unit, text input unit, and all other units, modules, elements, and methods described above may be implemented using one or more hardware components, or a combination of one or more hardware components and one or more software components. A hardware component may be, for example, a physical device that physically performs one or more operations, but is not limited thereto. Examples of hardware components include controllers, microphones, amplifiers, low-pass filters, high-pass filters, band-pass filters, analog-to-digital converters, digital-to-analog converters, and processing devices.

A processing device may be implemented using one or more general-purpose or to special-purpose computers, such as, for example, a processor, a controller and an arithmetic logic unit, a digital signal processor, a microcomputer, a field-programmable array, a programmable logic unit, a microprocessor, or any other device capable of running software or executing instructions. The processing device may run an operating system (OS), and may run one or more software applications that operate under the OS. The processing device may access, store, manipulate, process, and create data when running the software or executing the instructions. For simplicity, the singular term “processing device” may be used in the description, but one of ordinary skill in the art will appreciate that a processing device may include multiple processing elements and multiple types of processing elements. For example, a processing device may include one or more processors, or one or more processors and one or more controllers. In addition, different processing configurations are possible, such as parallel processors or multi-core processors.

Software or instructions for controlling a processing device, such as those described in FIGS. 6 and 7, to implement a software component may include a computer program, a piece of code, an instruction, or some combination thereof, for independently or collectively instructing or configuring the processing device to perform one or more desired operations. The software or instructions may include machine code that may be directly executed by the processing device, such as machine code produced by a compiler, and/or higher-level code that may be executed by the processing device using an interpreter. The software or instructions and any associated data, data files, and data structures may be embodied permanently or temporarily in any type of machine, component, physical or virtual equipment, computer storage medium or device, or a propagated signal wave capable of providing instructions or data to or being interpreted by the processing device. The software or instructions and any associated data, data files, and data structures also may be distributed over network-coupled computer systems so that the software or instructions and any associated data, data files, and data structures are stored and executed in a distributed fashion.

For example, the software or instructions and any associated data, data files, and data structures may be recorded, stored, or fixed in one or more non-transitory computer-readable storage media. A non-transitory computer-readable storage medium may be any data storage device that is capable of storing the software or instructions and any associated data, data files, and data structures so that they can be read by a computer system or processing device. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, or any other non-transitory computer-readable storage medium known to one of ordinary skill in the art.

Functional programs, codes, and code segments for implementing the examples disclosed herein can be easily constructed by a programmer skilled in the art to which the examples pertain based on the drawings and their corresponding descriptions as provided herein.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A recording device, comprising:
a data recording unit configured to record to a storage medium data that is received from a terminal device; and
a text input unit that is on a surface of the data recording unit for enabling a user to input text into the terminal device.

2. The recording device of claim 1, wherein the text input unit is a keypad that is capable of being separated and spaced apart from the data recording unit by the user.

3. The recording device of claim 2, wherein the text input unit is configured to receive or transmit data by wireless communication with the terminal device in response to being separated and spaced apart from the data recording unit.

4. The recording device of claim 1, wherein the text input unit is a keypad that is capable of slidably detaching from and reattaching to the data recording unit by the user.

5. The recording device of claim 4, wherein the text input unit comprises a supporter for supporting the text input unit on a surface in response to the text input unit being detached from the data recording unit.

6. The recording device of claim 1, wherein the text input unit is a keypad that comprises any one or any combination of a number key, a character key, and an emoticon key.

7. The recording device of claim 4, wherein the text input unit enables the user to input any one or any combination of a number, a character, and an emoticon using a touch scheme or a typing scheme.

8. The recording device of claim 1, wherein the storage medium is any one or any combination of an optical disk and a hard disk.

9. The recording device of claim 1, wherein the text input unit is configured to receive data identification information from the user and to label the storage medium with the data identification information.

10. The recording device of claim 1, wherein the text input unit comprises a display configured to enable the user to verify whether data identification information is input.

11. A recording device, comprising:
an opening for receiving an optical disk, wherein
the recording device is capable of recording data to the optical disk and is connected to a keypad that is capable of inputting text into a terminal device.

12. The recording device of claim 11, wherein the keypad is capable of being separated and spaced apart from a data recording unit by a user.

13. The recording device of claim 11, wherein the keypad is capable of slidably detaching from and reattaching to a data recording unit by a user.

14. The recording device of claim 13, wherein the keypad comprises a supporter for supporting the keypad on a surface in response to the keypad being detached from the data recording unit.

15. The recording device of claim 11, wherein the recording device is configured to label the optical disk with data identification information in response to the data identification information being received by the keypad.

16. The recording device of claim 11, wherein the keypad comprises any one or any combination of a number key, a character key, and an emoticon key that enable a user to input any one or any combination of a number, a character, and an emoticon using a touch scheme or a typing scheme.

17. The recording device of claim 11, wherein the keypad comprises any one or any combination of a number key, a character key, and an emoticon key.

18. A keypad, comprising:
a surface for combining with an upper plate of a recording device, wherein
the recording device is capable of recoding data to a storage medium; and
the keypad is capable of transmitting input data to a terminal device.

19. The keypad of claim 18, wherein the keypad is capable of being separated and spaced apart from the recording device or slidably detaching from and reattaching to the recording device.
